(19) United States
(12) Patent Application Publication
(10) Pub. No.: US 2014/0159994 A1
(43) Pub. Date: Jun. 12, 2014

(54) COMBINED HUD/HDD DISPLAY

(71) Applicant: L3 Communications Corporation, New York, NY (US)

(72) Inventor: Joseph H. GARCIA, Gainesville, GA (US)

(73) Assignee: L3 Communications Corporation, New York, NY (US)

(21) Appl. No.: 14/096,727

(22) Filed: Dec. 4, 2013

Related U.S. Application Data
(60) Provisional application No. 61/733,290, filed on Dec. 4, 2012.

(51) Int. Cl. G06F 3/14; G02F 1/13; G02B 27/01

(52) U.S. Cl. CPC G06F 3/1431; G02B 27/01; G02F 1/1313
USPC 345/3.1

(57) ABSTRACT

An integrated dual-mode visual display system which includes both a large-area heads down display and a heads up display combined in a single unit includes a housing or chassis, a flat panel display attached to the housing or chassis, a HUD projector for projecting HUD images and/or data, and a processor housed within the housing or attached to the chassis for driving both the HUD projector and the flat panel display. The processor comprises a video generator for generating video images to be displayed on the flat panel display and on the HUD. The HUD and the HDD (the flat panel display) can display the same information, completely distinct information, or information that has some commonality (some information is uniquely displayed on one or the other of the HUD and HDD displays, while some information is displayed on both the HUD and the HDD).

### BACKGROUND

The present invention relates to display systems for vehicles, such as airplanes for example, and more particularly relates to “heads up displays” (HUDs) and “heads down displays” (HDDs).

In the known prior art, it is common to use an HUD or an HDD to display data or images for use by an operator. Known HDD displays can take many forms, such as traditional analog instrumentation, digital instrumentation, flat panel displays (FPDs), etc. These types of displays can consume substantial space in the vehicle. While FPDs can replace numerous analog or digital instruments, known FPDs still require space for dedicated input connections, dedicated information or video processing, and an output device (the visual display). Likewise, HUDs can require similar amounts of space for similar requirements (inputs, processing, output). Typically, space inside the vehicle is limited and these HUD and HDD systems compete for limited space in the vehicle.

Indeed, in the prior art the available instrument panel space in certain types of vehicles does not allow for the installation of both a large-area HDD and a HUD since both of these electronic visual displays need to occupy the same installation space behind the center of the instrument panel. Therefore, multiple, smaller area HDDs are installed in the vehicle's instrument panel in such a way as to make HUD installation space available behind the instrument panel and cantilevered towards the pilot (or other operator) for heads up display viewing.

Accordingly, it can be seen that there exists a need for a vehicle display system which is compact and can display both head up display information and heads down display information. It is to the provision of such that the present invention is primarily directed.

### SUMMARY OF THE INVENTION

Briefly described, the present invention relates to an integrated dual-mode visual display system which includes both a large-area heads down display and a heads up display combined in a single unit. In one example form, the present invention comprises a dual-mode visual display system including a housing or chassis, a flat panel display attached to the housing or chassis, a HUD projector for projecting HUD images and/or data, and a processor housed within the housing or attached to the chassis for driving both the HUD projector and the flat panel display. Preferably, the processor comprises a video generator for generating video images to be displayed on the flat panel display and on the HUD. Optionally, the HUD and the HDD (the flat panel display) can display the same information, completely distinct information, or information that has some commonality (some information is uniquely displayed on one or the other of the HUD and HDD displays, while some information is displayed on both the HUD and the HDD).

Defined another way, the present invention comprises a large area heads down display surface, a transparent image combiner display surface located in the operator's line of sight, and the associated optical, electrical, and structural elements required for the function of the electronic visual display unit. Optionally, the head down display utilizes an Active Matrix Liquid Crystal Display (AMLCD) element.

Stated yet another way, the present invention relates to an improvement in vehicles having both a heads down display and a HUD display. The improvement comprises that the HDD and the HUD are associated with a single, common chassis or housing and the single, common chassis or housing houses a video processor for generating and delivering video to each of the HDD and to the HUD. In this way, less space is needed to mount and operate the HDD and the HUD display.

### BRIEF DESCRIPTION OF THE DRAWING FIGURES

FIG. 1 is a schematic block diagram depicting the main functional components of a display system according to an example form of the present invention.

FIG. 2 is a perspective view of a combined HUD/HDD device according to an example form of the present invention.

FIG. 3 is a front elevation view of the combined HUD/HDD device of FIG. 2.

FIG. 4 is a side elevation view of the combined HUD/HDD device of FIG. 2.

FIG. 5 is a partially-exploded perspective view of the combined HUD/HDD device of FIG. 2.

FIG. 6 is a perspective view of a prior art aircraft instrument panel including a HUD device.

FIG. 7 is a perspective view of an example of the combined HUD/HDD device of FIG. 2, shown mounted in a cockpit of an aircraft.

### DESCRIPTION OF EXAMPLE EMBODIMENTS

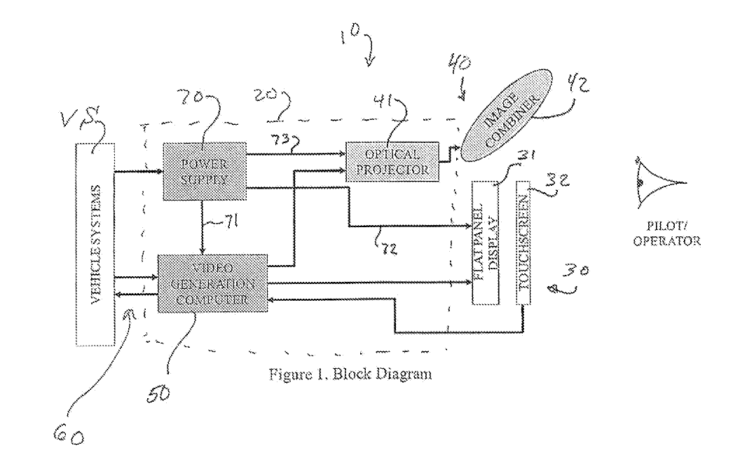

An example of the present invention is shown in FIG. 1, schematically depicting a dual-mode visual display system 10 for a vehicle. The dual-mode visual display system 10 comprises a frame or chassis 20, an HDD flat panel display 30 attached to the frame 20, and a HUD 40. Preferably the HUD 40 includes a HUD projector 41 attached to the frame 20 for projecting HUD images and/or data and an image combiner 42 supported by the frame 20 for displaying the HUD images. Preferably, a video processor 50 in the form of a video generation computer is mounted to the frame 20 for driving both the HUD projector 40 and the HDD 30.

Preferably, the HDD or flat panel display 30 comprises a large-area heads down display 31 (as shown) and a touchscreen 32. In one form, the large area flat panel display 31 utilizes an Active Matrix Liquid Crystal Display (AMLCD) element.

Preferably, the video processor 50 is adapted to at times drive the HUD projector 41 and the large area flat panel display 31 to display the same information on both the HUD projector and the HDD.

Optionally, the video processor 50 is adapted to at times drive the HUD projector 41 and the large area flat panel display 31 to display different information on both the HUD projector and the HDD at all times.

Alternatively, the video processor 50 is adapted to at times drive the HUD projector 41 and the large area flat panel display 31 to display the same information on both the HUD projector and the HDD and to at other times drive the HUD projector and the flat panel display to display different information on the HUD projector and the HDD.

Preferably, the video processor 50 is electrically coupled to the vehicle's systems VS via an input/output coupling 60. This input/output coupling 60 can take various forms, including analog inputs and outputs, an IEEE serial connection, an IEEE parallel connection, video cables, etc. Also, the coupling can be implemented as a single input/output coupling that provides input and output for both the HDD and the HUD. Alternatively, the coupling can be implemented as two input/output connections such that the HDD has its own dedicated coupling to one or more vehicle systems and the HUD has its own dedicated coupling to one or more vehicle systems.

Preferably, a single power supply 70 is provided to supply electric power to the video processor 50, the large area flat panel display 31, the optical projector 41, etc. For example, as shown in FIG. 1, power supply 70 supplies electric power to the video processor 50 via power cabling 71, supplies electric power to the large area flat panel display 31 via power cabling 72, and supplies electric power to the optical projector 41 via power cabling 73. Alternatively, multiple power supplies can be provided, if desired, such as for redundancy or to isolate power supply failure problems to one or the other of the HUD and the HDD. Preferably, the electrical power provided by the vehicle system to the power supply 70 is conditioned by the power supply and distributed to the electrical subassemblies.

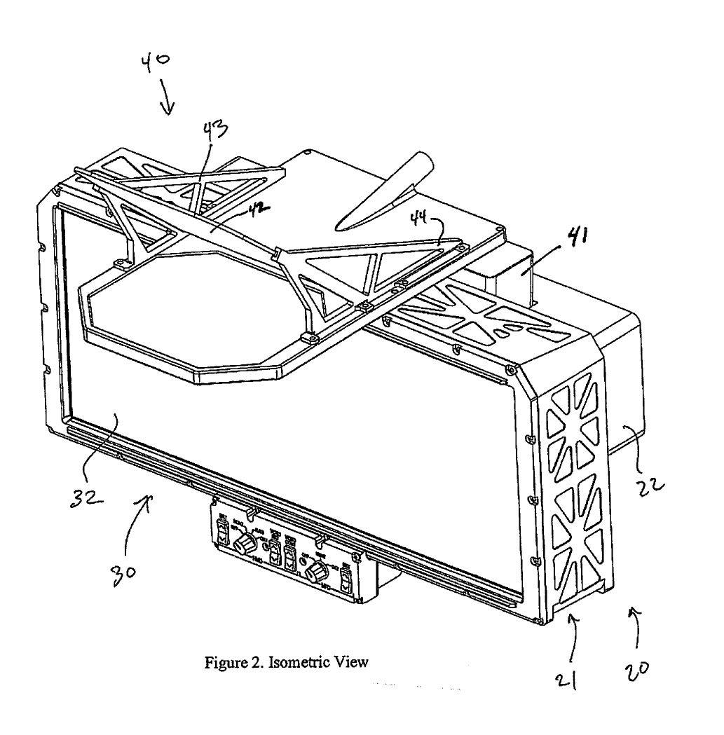

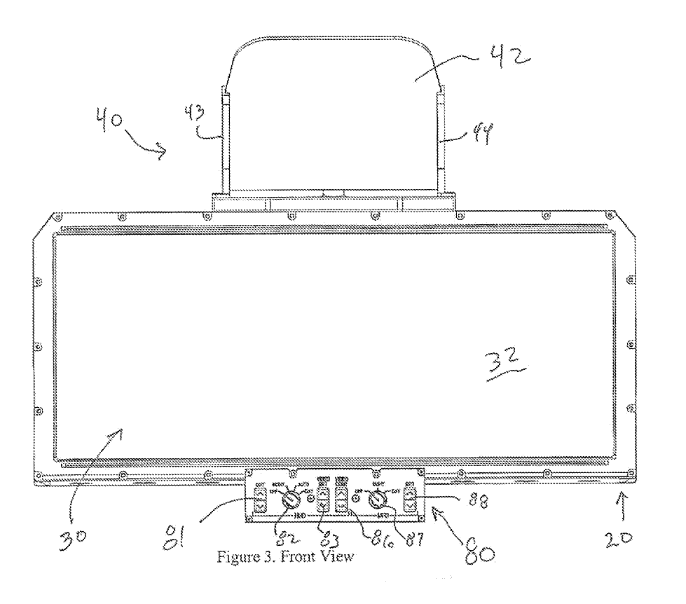

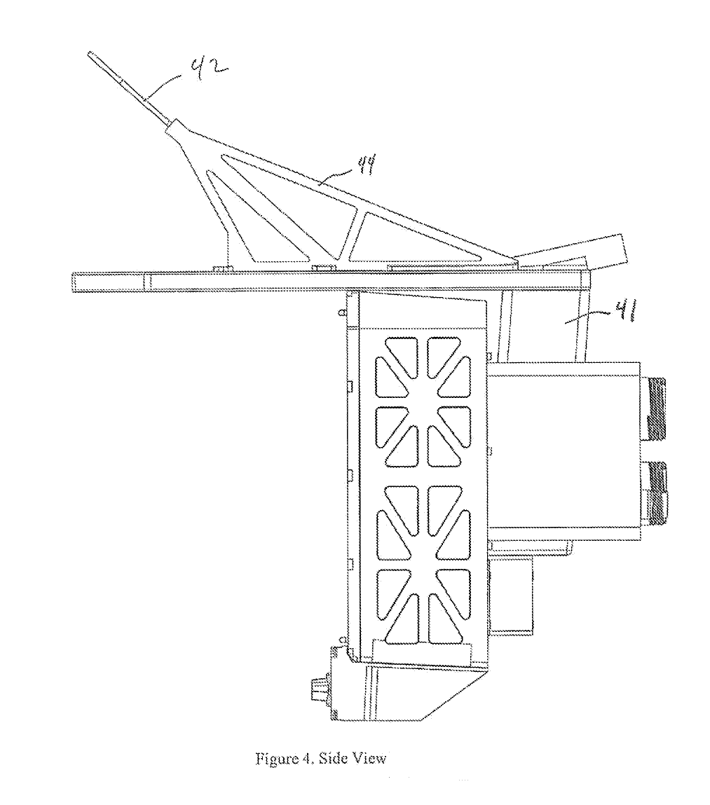

As seen in FIGS. 2-5, in one preferred form of the invention the frame or chassis 20 is in the form of a generally rectangular enclosure, with a first enclosure portion 21 positioned in front of a second, smaller enclosure portion 22. The frame or chassis 20 supports a touchscreen 32 (part of the large area flat panel display 30 or HDD). Preferably the HUD 40 includes a HUD projector 41 supported by the frame 20 for projecting HUD images and/or data and an image combiner 42 supported by the frame 20. The combiner 42 is supported by a pair of side brackets 43, 44 that are attached to the frame or chassis 20 and extend upwardly and forwardly at an angle to position the image combiner at an angle relative to the top of the frame or chassis (and thereby at an angle relative to the human operator/pilot). Thus, the frame or chassis 20 supports both the HUD 40 and the flat panel display 30 (HDD).

The frame or chassis 20 also supports a unified control panel 80 just below the flat panel display 30 and centrally located thereunder. The unified control panel 80 optionally includes the following controls: HUD Brightness rocker 81, HUD Off/Night/Auto/Day switch 82, HUD Video Brightness rocker 83, HUD Video Control rocker 86, HDD Off/Night/Day switch 87, and HDD Brightness rocker 88. Those skilled in the art will readily recognize that other types of controls can be substituted or added, as desired.

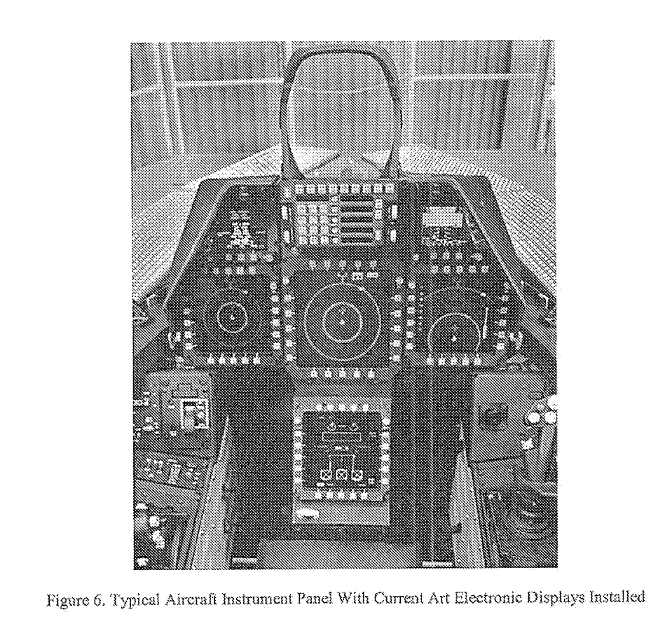

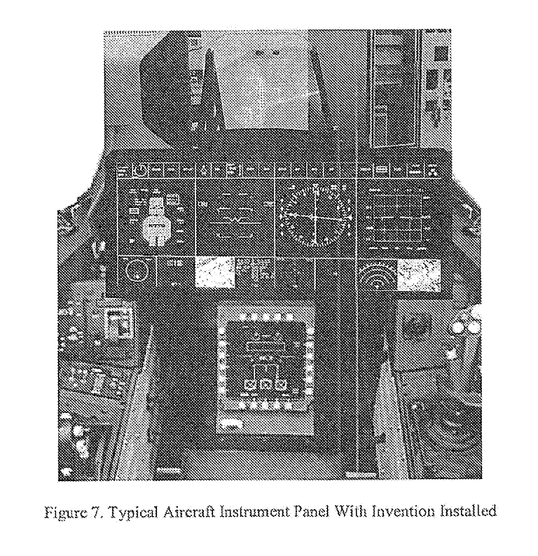

Preferably, the flat panel display 30 comprises a large-area heads down display 31 (as shown) and a touchscreen 32. In one preferred form, the flat panel display utilizes an Active Matrix Liquid Crystal Display (AMLCD) element. Advantageously, because of the space savings achieved by combining these two disparate types of displays into a single installation, more room is freed up to make the flat panel display larger. This larger flat panel display is thus easier to read. This dramatic improvement is easily seen by comparing the prior art aircraft instrument panel of FIG. 6 with the implementation of the present invention as shown in FIG. 7.

The present invention advantageously combines, where possible and practical, various components of a flat panel display system and of a HUD display system into a combined display system that provides the functionality of both disparate types of displays and does so in a manner to minimize space requirements. Thus, this allows both a HUD and HDD display to be used in environments where previously only one or the other could be used because of space constraints. Moreover, this space requirement reduction also allows the placement of additional components, if desired. Also, this allows the resulting flat panel display to have a larger display screen (as less space is wasted on housings/frames/electronics/etc.). The two electronic visual displays (HDD and HUD) of this invention can have some distinct components as well as shared components.

The shared components of this invention can optionally include a video generation computer (video processor), an electrical power supply, and various components dedicated to thermal management, chassis and/or housing, structural integrity, and other elements commonly needed for the operation of an electronic visual display unit. The components dedicated to the heads up display function typically will include an optical projector subassembly and an image combiner element. The components dedicated to the large area heads down display function typically will include a flat panel display subassembly and optional human-machine interface subassemblies, such as a control panel, touch-screen overlay, cursor pointing device, etc.

Optionally, the shared components (e.g., video generation computer, electrical power supply, etc.) are located behind the large area heads down display and below the heads up display. Preferably, the components dedicated to the heads up display function are located behind and above the large area heads down display. The components dedicated to the large area heads down display preferably are located in front of the shared components and below and in front of the heads up display components.

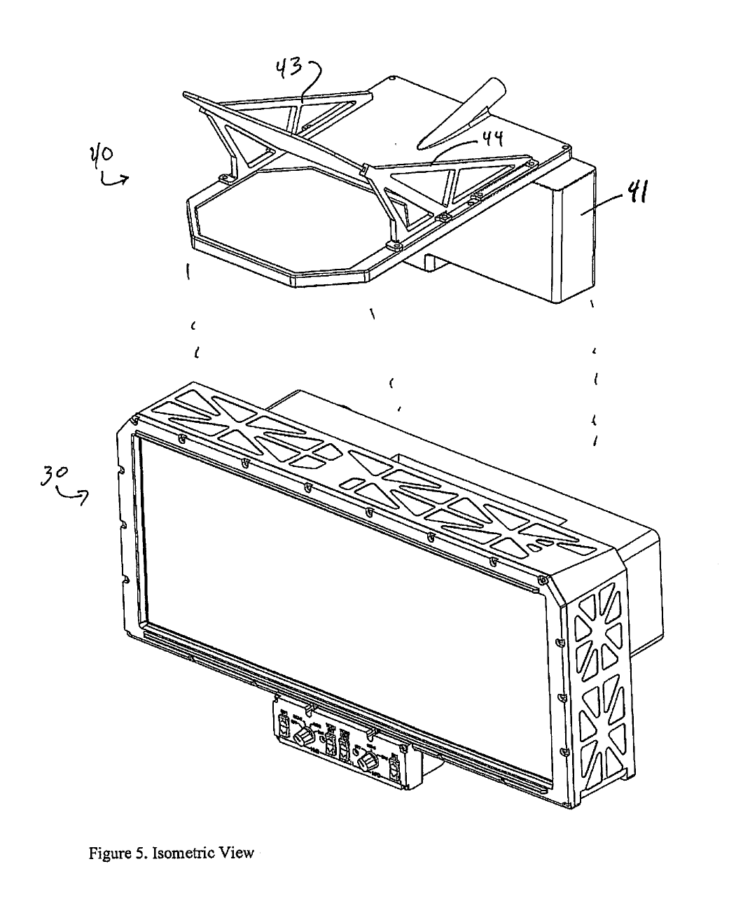

Optionally, as shown in FIG. 5, the device can be configured as a notional multi-piece servicing apparatus to improve ease of installation in applications with confined space constraints.

Optionally, video input is provided by the vehicle system(s) to the video generation computer 50 and is processed therein as required. Note that any number of independent video inputs may provided by the vehicle system to the video generation computer 50. These video inputs may be routed to a specific display (HUD or HDD), may be routed to both displays simultaneously, or may be merged into unique combinations and routed to each display. After merging and routing, the video generation computer formats the video image according to the interface requirements of the HUD and HDD before transmitting the video to the display subassemblies.

Video routed to the HUD display surface is transmitted electrically to the Optical Projector subassembly. The Optical Projector projects the image optically to the Image Combiner 42 where it is viewed by the vehicle pilot/operator.

Video routed to the HDD display surface is transmitted electrically to the flat panel display 30. The flat panel display presents the image on the front surface of the large area flat panel display 31 where it is viewed by the vehicle pilot/operator through the optional touchscreen 32.

Optionally, a user interface device, such as a touchscreen 32, may be provided on the front surface of the flat panel display 30. This user interface device may be used by the pilot/operator to interface with the video generation computer 50.

In a novel manner, the Heads Down Display (HDD) and the Heads Up Display (HDD) are combined in the same physical Line Replaceable Unit (LRU). This physical combination allows the two display types to share the same physical space, as well as common structural, thermal, interconnect, and other physical attributes. In the prior art, these two display types occupy separate physical spaces with separate structural, thermal, interconnect, and other physical attributes.

Notably, preferably a common power supply and video generation computer are utilized to provide electrical and video inputs to the HDD and HUD display types. In the known prior art, these two display types require separate power supply and video generation computer subassemblies.

In addition to the single, generally unitary (inseparable) assembly construction, the invention can also be comprised of multiple, separable subassemblies to improve the ease of installation in vehicle applications where there are particularly confined physical space constraints. Once the multiple subassemblies are installed and mated together in the vehicle, the resulting assembly comprises a single Line Replaceable Unit (LRU) with all of the benefits of the invention as described previously herein. An example of this multiple subassembly approach is shown in FIG. 5 in which the HUD 40 is separable from the remainder of the frame/chassis 20 and the HDD 30.

The operators (pilots, drivers, etc.) of vehicles utilizing this invention can benefit from improved situational awareness available due to having both the increased display surface area on the instrument panel (provided by the large area heads down display function) and the ability to view vehicle information while simultaneously looking at viewpoints outside the vehicle (provided by the heads up display function). The manufacturers, owners, and maintainers of vehicles utilizing this invention can benefit from lower initial system cost, improved system reliability, and improved serviceability resulting from replacing multiple electronic display LRUs with a single electronic display LRU.

The present invention provides significant improvements over the prior art, including: elimination of the installation space conflict and resultant tradeoffs; significant increase in the instrument panel display surface area available to the vehicle operator; and a significant reduction in the number of line replaceable units (LRUs) required in the instrument panel.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “one” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in exemplary forms, it will be apparent to those skilled in the art that many modifications, additions, and deletions can be made therein without departing from the spirit and scope of the invention as defined by the following claims.

What is claimed is:

1. A dual-mode visual display system for a vehicle comprising:
a frame,
an HDD including a flat panel display attached to the frame, a HUD projector attached to the frame for projecting HUD images and/or data, and
a video processor mounted to the frame for driving both the HUD projector and the HDD.

2. A dual-mode visual display system as claimed in claim 1 wherein the flat panel display comprises a large-area heads down display.

3. A dual-mode visual display system as claimed in claim 1 wherein the HUD projector is part of a heads up display.

4. A dual-mode visual display system as claimed in claim 1 wherein the video processor comprises a video generator for generating video images to be displayed on the flat panel display and displayed with the HUD projector.

5. A dual-mode visual display system as claimed in claim 4 wherein the video processor is adapted to at times drive the HUD projector and the HDD to display the same information on both the HUD projector and the HDD.

6. A dual-mode visual display system as claimed in claim 4 wherein the video processor is adapted to at times drive the HUD projector and the HDD to display different information on both the HUD projector and the HDD at all times.

7. A dual-mode visual display system as claimed in claim 4 wherein the video processor is adapted to at times drive the HUD projector and the HDD to display the same information on both the HUD projector and the HDD and at other times to drive the HUD projector and the HDD to display different information on the HUD projector and the HDD.

8. A dual-mode display system as claimed in claim 1 wherein the flat panel display utilizes an Active Matrix Liquid Crystal Display (AMLCD) element.

9. A dual-mode display system as claimed in claim 1 wherein the frame comprises a housing and the video processor is housed within the housing and drives both the HUD projector and the HDD.

10. A dual-mode display system for vehicles comprises a large area HDD, a HUD display located in the operator's line of sight, and associated optical, electrical, and structural elements for driving the HDD and the HUD.

11. A dual-mode display system as claimed in claim 10 wherein the HDD utilizes an Active Matrix Liquid Crystal Display (AMLCD) element.

12. In a vehicle of the type having a display, the improvement therein comprising that the display includes both an HDD and an HUD, both of which are associated with a single, common chassis or housing and wherein the single, common chassis or housing houses a video processor for generating and delivering video to each of the HDD and to the HUD.
